(19) United States
(12) Patent Application Publication
(10) Pub. No.: US 2010/0159947 A1
(43) Pub. Date: Jun. 24, 2010

(54) POSITION CALCULATING METHOD AND POSITION CALCULATING DEVICE

(75) Inventor: Shigeru Imafuku, Shiojiri-shi (JP)

Correspondence Address: GLOBAL IP COUNSELORS, LLP, 1233 20TH STREET, NW, SUITE 700, WASHINGTON, DC, 20036-2680, US

(73) Assignee: SEIKO EPSON CORPORATION, Tokyo (JP)

(21) Appl. No.: 12/631,928

(22) Filed: Dec. 7, 2009

(30) Foreign Application Priority Data
Dec. 24, 2008 (JP) 2008-327077

(51) Int. Cl. H04W 64/00

(52) U.S. Cl. 455/456.1

(57) ABSTRACT

A position calculating method performed by a position calculating device carried with or mounted on a mobile body and moving with the mobile body, includes: receiving a positioning signal from a positioning satellite; calculating a position based on the received positioning signal; intermittently operating a sensor unit which detects moving condition of the mobile body in predetermined intermittent operation cycle; controlling the intermittent operation cycle according to the positioning signal receiving condition; calculating a position by executing predetermined inertial navigation calculation by using a detection result from the sensor unit operated in the intermittent operation cycle; and determining an output position by using the position calculated based on the positioning signal and the position calculated by the inertial navigation calculation.

### CROSS-REFERENCE

The entire disclosure of Japanese Patent Application No. 2008-327077, filed Dec. 24, 2008 is expressly incorporated by reference herein.

### BACKGROUND

1. Technical Field

The present invention relates to a position calculating method performed by a position calculating device carried with or mounted on a mobile body and moving with the mobile body, and others.

2. Related Art

GPS (global positioning system) is widely known as a positioning system which uses positioning signals. The GPS is included in a position calculating device contained in a cellular phone, a car navigation system and the like. The GPS performs position calculation for obtaining three-dimensional coordinate values indicating the GPS and time error based on information such as positions of plural GPS satellites and pseudo distances between the respective GPS satellites and the GPS.

According to the position calculation using the positioning signals, position calculation accuracy lowers by various error factors. Thus, various types of technologies for improving position calculation accuracy have been developed. For example, JP-A-2008-107218 discloses a technology which performs inertial navigation calculation based on detection results from a sensor unit detecting the moving condition of a mobile body and corrects positions calculated according to positioning signals by using positions calculated by the inertial navigation calculation.

Generally, the sensor unit constantly performs detection. In most cases, the position calculating device calculates movement vectors of the mobile body based on the detection results detected at predetermined time intervals by the sensor unit which constantly performs detection. Thus, accuracy in inertial navigation calculation can be increased by shortening the time intervals for obtaining the detection results to be used and calculating movement vector for each time interval.

On the other hand, there is a demand for decreasing power consumption by reducing operation of the sensor unit as much as possible. The power consumption can be lowered by intermittently operating the sensor unit. However, in view of improvement on inertial navigation calculation accuracy discussed above, it is desired that the operation time interval of the sensor unit is the shortest possible term. Thus, in case of position calculation using the sensor unit, the accuracy in calculated position and reduction of power consumption for driving the sensor unit are conflicting issues.

### SUMMARY

It is an advantage of some aspects of the invention to provide a technology of appropriate position calculation considering the balance between accuracy in position calculation and power consumption of a sensor unit.

A first aspect of the invention is directed to a position calculating method performed by a position calculating device carried with or mounted on a mobile body and moving with the mobile body, the position calculating method including: receiving a positioning signal from a positioning satellite; calculating a position based on the received positioning signal; intermittently operating a sensor unit which detects moving condition of the mobile body in predetermined intermittent operation cycle; controlling the intermittent operation cycle according to the positioning signal receiving condition; calculating a position by executing predetermined inertial navigation calculation by using a detection result from the sensor unit operated in the intermittent operation cycle; and determining an output position by using the position calculated based on the positioning signal and the position calculated by the inertial navigation calculation.

Another aspect of the invention is directed to a position calculating device carried with or mounted on a mobile body and moving with the mobile body, the position calculating device including: a receiving unit which receives a positioning signal from a positioning satellite; a first position calculating unit which calculates a position based on the received positioning signal; a sensor operation control unit which intermittently operates a sensor unit for detecting moving condition of the mobile body in predetermined intermittent operation cycle; an operation cycle control unit which controls the intermittent operation cycle according to the positioning signal receiving condition; a second position calculating unit which calculates a position by executing predetermined inertial navigation calculation by using a detection result from the sensor unit operated in the intermittent operation cycle; and a position determining unit which determines an output position by using the position calculated based on the positioning signal and the position calculated by the inertial navigation calculation.

According to the aspects of the invention, the sensor unit for detecting the moving condition of the mobile body is intermittently operated in the predetermined intermittent operation cycle. This intermittent operation cycle is controlled according to the positioning signal receiving condition. Then, the position is calculated by performing the predetermined inertial navigation calculation based on the detection result from the sensor unit operated in the intermittent operation cycle to determine the output position by using the position calculated by the position signal and the position calculated by the inertial navigation calculation.

When the positioning signal receiving condition is preferable, it is probable that the position calculated based on the positioning signal is highly accurate. Thus, the position calculated by the inertial navigation calculation need not be highly accurate. In this case, the intermittent operation cycle of the sensor unit is set long. When the positioning signal receiving condition is not preferable, it is probable that the position based on the positioning signal is not accurate. Thus, the position calculated by the inertial navigation calculation needs to be highly accurate. In this case, the intermittent operation cycle of the sensor unit is set short. By this method, appropriate position calculation considering balance between the accuracy of position calculation and the power consumption of the sensor unit can be achieved.

A second aspect of the invention is directed to the position calculating method of the first aspect, the method further including: predicting position and moving speed of the mobile body by performing prediction calculation based on Kalman filter theory; predicting frequency of the positioning signal received at the predicted position by using the predicted position and moving speed; and controlling the intermittent operation cycle based on the difference between the predicted frequency and the frequency of the received positioning signal.

According to the second aspect of the invention, the position and moving speed of the mobile body are predicted by performing prediction calculation based on the theory of Kalman filter. Then, the frequency of the positioning signal received at the predicted position is predicted by using the predicted position and moving speed. Subsequently, the intermittent operation cycle of the sensor unit is controlled based on the difference between the predicted frequency and the frequency of the positioning signal actually received.

When the positioning signal receiving condition is preferable, it is probable that the predicted frequency of the positioning signal by using the predicted position and moving speed is close to the frequency of the positioning signal actually received. Thus, the receiving condition of the positioning signal can be recognized by using the frequency difference as a decision base, and appropriate intermittent operation cycle of the sensor unit can be set.

A third aspect of the invention is directed to the position calculating method of the second aspect, the method further including: predicting phase of the positioning signal received at the predicted position by using the predicted position and moving speed; and controlling the intermittent operation cycle based on the difference between the predicted phase and the phase of the received positioning signal.

According to the third aspect of the invention, the phase of the positioning signal received at the predicted position is predicted by using the predicted position and moving speed. Then, the intermittent operation cycle of the sensor unit is controlled based on the difference between the predicted phase and the phase of the received positioning signal. In this case, advantages similar to those of the second aspect of the invention are offered.

A fourth aspect of the invention is directed to the position calculating method of the third aspect, the method further including: predicting the frequency and phase at predetermined intervals; and controlling the intermittent operation cycle every time prediction is executed at the predetermined intervals.

According to the fourth aspect of the invention, the intermittent operation cycle of the sensor unit is controlled every time the frequency and phase are predicted at the predetermined intervals. By this method, the intermittent operation cycle of the sensor unit can be adequately controlled at the time of position calculation.

A fifth aspect of the invention is directed to the position calculating method of any of the first through fourth aspects, the method further including controlling the intermittent operation cycle based on history of the positioning signal receiving condition.

According to the fifth aspect of the invention, the intermittent operation cycle of the sensor unit is controlled based on the history of the positioning signal receiving condition. For example, it is preferable that the intermittent operation cycle of the sensor unit is gradually increased as the positioning signal receiving condition gradually becomes better, and that the intermittent operation cycle of the sensor unit is gradually decreased as the positioning signal receiving condition gradually becomes poorer.

A sixth aspect of the invention is directed to the position calculating method of any of the first through fifth aspects, the method further including: determining the moving condition of the mobile body from the positioning signal receiving condition; and controlling the intermittent operation cycle based on the moving condition of the mobile body.

According to the sixth aspect of the invention, the moving condition of the mobile body is determined from the positioning signal receiving condition. Then, the intermittent operation cycle of the sensor unit is controlled based on the moving condition of the mobile body. When it is determined that the moving condition of the mobile body is in unstable condition such as high acceleration condition or rotation condition, the accuracy in position calculation based on the positioning signal lowers. Thus, it is preferable that the accuracy in inertial navigation calculation is increased by reducing the intermittent operation cycle of the sensor unit.

A seventh aspect of the invention is directed to the position calculating method of any of the first through sixth aspects, the method further including: determining the positioning signal receiving environment from the positioning signal receiving condition; and controlling the intermittent operation cycle based on the receiving environment.

According to the seventh aspect of the invention, the position signal receiving environment is determined from the positioning signal receiving condition. Then, the intermittent operation cycle of the sensor unit is controlled based on the receiving environment. When the positioning signal receiving environment is poor, the accuracy in position calculation based on the positioning signal lowers. Thus, it is preferable that the accuracy in inertial navigation calculation is increased by reducing the intermittent operation cycle of the sensor unit.

### BRIEF DESCRIPTION OF THE DRAWINGS

The invention will be described with reference to the accompanying drawings, wherein like numbers reference like elements.

FIG. 1 is a block diagram showing a function structure of a cellular phone.

FIG. 2 shows an example of data stored in a ROM.

FIG. 3 shows an example of data stored in a RAM.

FIG. 4 is a graph showing changes of actual values and prediction values of reception frequency with time.

FIG. 5 is a graph showing changes of actual values and prediction values of code phase with time.

FIG. 6 shows accuracy in position calculation in accordance with difference in sampling time interval.

FIG. 7 is a graph showing an example of changes of sampling time intervals with time.

FIG. 8 shows an example of data structure of sampling time interval setting data.

FIG. 9 shows an example of data structure of sensor data.

FIG. 10 shows an example of data structure of measurement data for each satellite.

FIG. 11 shows an example of data structure of measurement history data.

FIG. 12 is a flowchart showing flow of main process.

FIG. 13 is a flowchart showing flow of position calculation process.

FIG. 14 is a flowchart showing the flow of the position calculation process.

FIG. 15 is a flowchart showing flow of KF prediction process.

FIG. 16 is a flowchart showing flow of sampling time interval setting process.

FIG. 17 is a flowchart showing flow of KF correction process.

FIG. 18 is a flowchart showing flow of inertial navigation calculation process.

FIG. 19 shows an example of data structure of sampling time interval setting data in a modified example.

FIG. 20 shows an example of data structure of sampling time interval setting data in a modified example.

### DESCRIPTION OF EXEMPLARY EMBODIMENT

A cellular phone 1 as an example of electronic device including a position calculating device according to an embodiment of the invention is hereinafter described with reference to the drawings. The cellular phone 1 moves while carried by a user or mounted on an automobile or the like. In this embodiment, a person or an object carrying the cellular phone 1 is referred to as “mobile body”, and various directions detected by the cellular phone 1 correspond to the directions of the mobile body. It is intended that the invention is not limited to the embodiment described herein.

### 1. Function Structure

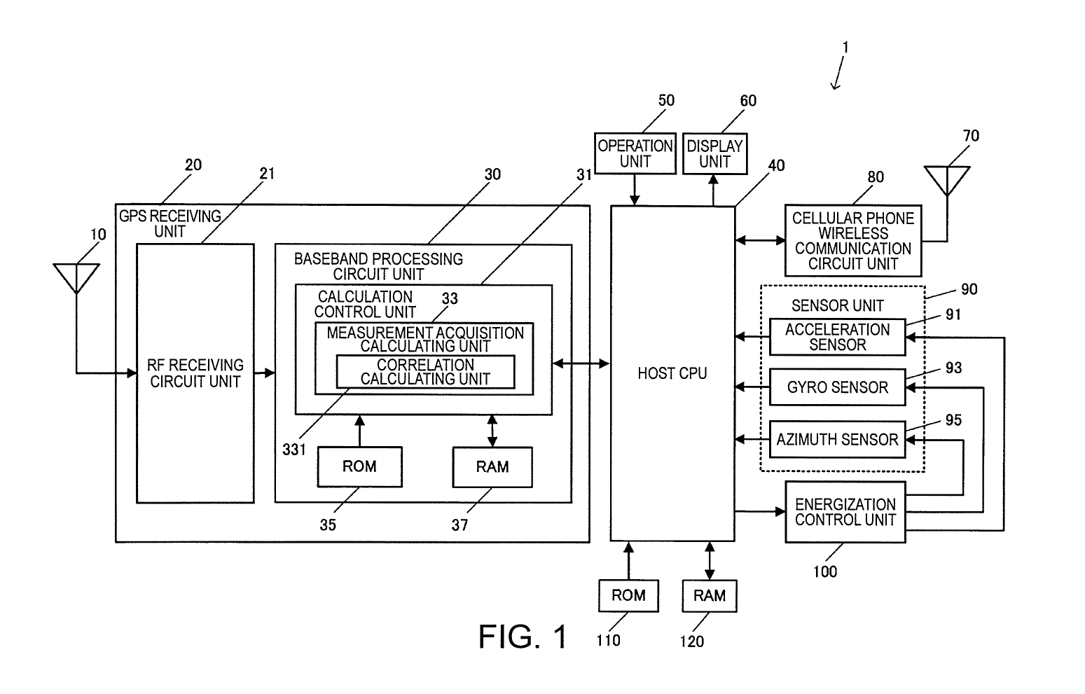

FIG. 1 is a block diagram showing the function structure of the cellular phone 1. The cellular phone 1 includes a GPS antenna 10, a GPS receiving unit 20, a host CPU (central processing unit) 40, an operation unit 50, a display unit 60, a cellular phone antenna 70, a cellular phone wireless communication circuit unit 80, a sensor unit 90, an energization control unit 100, a ROM (read only memory) 110, and a RAM (random access memory) 120.

The GPS antenna 10 is an antenna which receives RF (radio frequency) signals containing GPS satellite signals transmitted from GPS satellites, and outputs the received signals to the GPS receiving unit 20. The GPS satellite signals are communication signals having 1.57542 [GHz] and modulated by direct spectrum diffusion system using PRN (pseudo random noise) codes as a type of diffusion codes different for each satellite. The PRN codes are pseudo random noise codes having repetitive cycle of 1 ms and having code length of 1,023 chips as 1PN frame.

The GPS receiving unit 20 is a position calculation circuit for calculating the position of the cellular phone 1 based on the signals outputted from the GPS antenna 10 as a function block corresponding to a so-called GPS receiver. The GPS receiving unit 20 includes an RF (radio frequency) receiving circuit unit 21, and a baseband processing circuit unit 30. The RF receiving circuit unit 21 and the baseband processing circuit unit 30 can be manufactured as separate LSI (large scale integration), or as 1 chip unit.

The RF receiving circuit unit 21 is a circuit block for processing RF signals, and produces oscillation signals to be multiplied by RF signals by dividing or multiplying predetermined local oscillation signals. The RF signals outputted from the GPS antenna 10 are multiplied by the produced oscillation signals to be down-converted into intermediate frequency signals (hereinafter referred to as “IF (intermediate frequency) signals”). Then, the IF signals are amplified or processed in other ways, and converted into digital signals by an A/D (analog/digital) converter to be outputted to the baseband processing circuit unit 30.

The baseband processing circuit unit 30 is a circuit unit for capturing and extracting GPS satellite signals by applying correlation process or the like to the IF signals outputted from the RF receiving circuit unit 21, and obtaining navigation messages, time information and the like by decoding data. The baseband processing circuit unit 30 has a calculation control unit 31, a ROM 35 and a RAM 37. The calculation control unit 31 has a measurement acquisition calculating unit 33.

The measurement acquisition calculating unit 33 is a circuit unit for capturing GPS satellite signals from reception signals (IF signals) outputted from the RF receiving circuit unit 21, and has a correlation calculating unit 331. The measurement acquisition calculating unit 33 obtains information such as reception frequency and code phase of GPS satellite signals, and outputs the obtained information as actual measurement values to the host CPU 40.

The correlation calculating unit 331 performs correlation calculation process for calculating and integrating correlation between PRN codes contained in the reception signals and replica codes generated within the device by using FFT calculation, for example, to capture GPS satellite signals from the reception signals. The replica codes are signals simulating the PRN codes generated as pseudo codes and contained in GPS satellite signals to be captured.

When the GPS satellite signals to be captured are correct, the PRN codes contained in the corresponding GPS satellite signals agree with the replica codes (capture success). When the GPS satellite signals are wrong, the PRN codes and the replica codes do not agree (capture failure). Thus, whether capture of GPS satellite signals has succeeded or not can be determined based on the peak of the calculated correlation values. Therefore, the replica codes are successively varied, and correlation calculation is performed between the corresponding replica codes and reception signals to capture GPS satellite signals.

The correlation calculating unit 331 executes the above correlation calculating process while varying frequency and phase of replica code generating signals. When agreement between frequency of replica code generating signals and frequency of reception signals, and agreement between phase of PRN codes and phase of replica codes are achieved, the correlation value becomes the maximum.

More specifically, the range of predetermined frequency and phase corresponding to capture target GPS satellite signals is set as search range. Then, correlation calculation in the phase direction for detecting the start position of the PRN codes (code phase) and correlation calculation in the frequency direction for detecting frequency are carried out within the search range. The search range is defined within a predetermined frequency sweep range around 1.57542 [GHz] as carrier wave frequency of GPS satellite signals for frequency, and within a code phase range of 1,023 chips as the chip length of PRN codes for phase.

The host CPU 40 is a processor which collectively controls the respective units of the cellular phone 1 according to various programs such as system program stored in the ROM 110. The host CPU 40 measures the position of the cellular phone 1 by performing position calculation process to determine an output position. Then, the host CPU 40 displays a navigation screen where the output position is plotted on the display unit 60.

The operation unit 50 is an input device which includes a tough panel, button switches and the like, and outputs signals corresponding to pressed keys and buttons to the host CPU 40. Various types of commands such as input of destination and request for display of navigation screen are inputted through operation of the operation unit 50.

The display unit 60 is a display device constituted by LCD (liquid crystal display) or the like to provide various displays corresponding to display signals received from the host CPU 40. The display unit 60 displays navigation screen, time information and the like.

The cellular phone antenna 70 is an antenna which transmits and receives cellular phone wireless signals to and from a wireless base station established by a communication service provider of the cellular phone 1.

The cellular phone wireless communication circuit unit 80 is a cellular phone communication circuit unit including an RF converting circuit, a baseband processing circuit and the like. The cellular phone wireless communication circuit unit 80 provides telephone communication, mail transmission and reception, and the like by modulating and demodulating cellular phone wireless signals and other processes.

The sensor unit 90 includes various sensors for detecting moving condition of the mobile body. For example, the sensor unit 90 has an acceleration sensor 91, a gyro sensor 93, and an azimuth sensor 95. The host CPU 40 calculates inertial navigation calculation position by performing predetermined inertial navigation calculation based on the detection results from the sensor unit 90.

The acceleration sensor 91 is a sensor for detecting orthogonal triaxial acceleration. The acceleration sensor 91 may be either distortion gauge type or piezoelectric type, or an MEMS (micro electrode mechanical systems) sensor.

The gyro sensor 93 is a sensor for detecting orthogonal triaxial angular speed and is disposed in such a position to have the same axial direction as that of the acceleration sensor 91, for example. The acceleration sensor 91 and the gyro sensor 93 may be one unit sensor.

The azimuth sensor 95 is a biaxial geomagnetic sensor constituted by element which increases and decreases resistance value and impedance value according to magnetic field intensity, for example. The azimuth sensor 95 detects the azimuth angle of the mobile body.

The energization control unit 100 is a circuit unit for controlling power supply to the sensor unit 90, and includes a circuit for switching a not-shown power source circuit, for example. The energization control unit 100 controls power supply to the sensor unit 90 such that the sensor unit 90 can intermittently operate in intermittent operation cycle according to sampling time intervals outputted from the host CPU 40. One cycle of the intermittent operation cycle is from one timing that the sensor unit 90 is supplied power until the next timing that the sensor unit 90 is supplied power.

The ROM 110 is a non-volatile read-only memory unit which stores various programs and data such as system program for controlling the cellular phone 1 by the host CPU 40 and program and data for providing navigation function.

The RAM 120 is a readable and writable volatile memory unit which has a work area for temporarily storing the system program performed by the host CPU 40, various processing programs, data used during various processes, process results and the like.

### 2. Data Structure

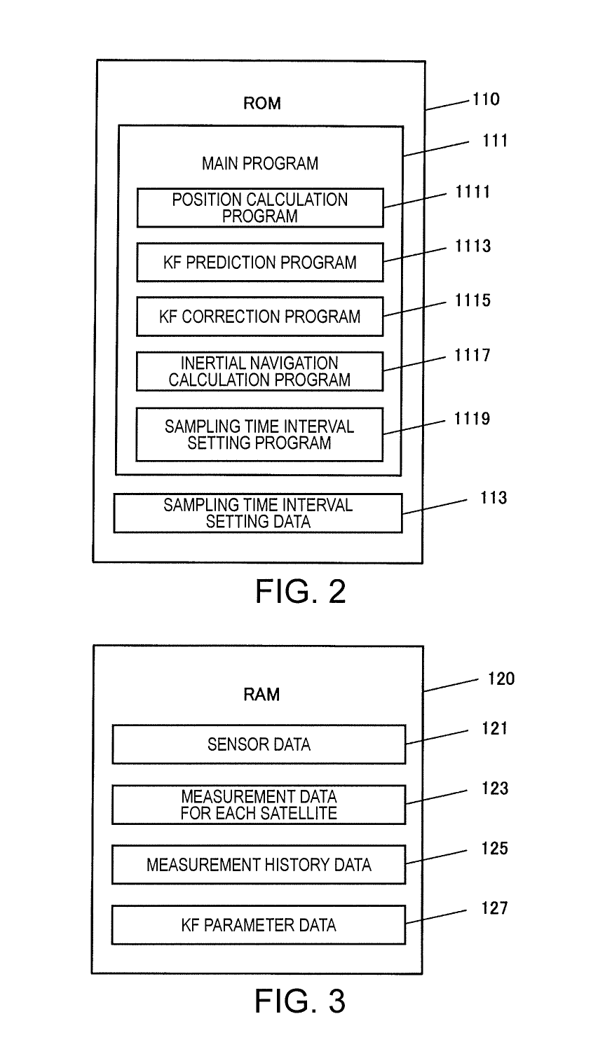

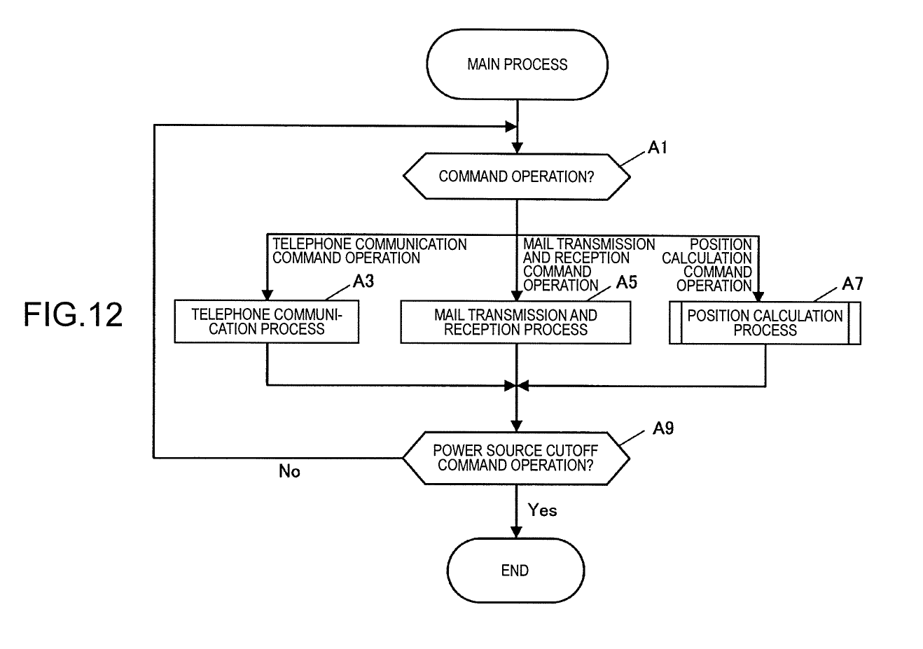

FIG. 2 shows an example of data stored in the ROM 110. The ROM 110 stores a main program 111 read by the host CPU 40 and performed in main process (see FIG. 12), and sampling time interval setting data 113.

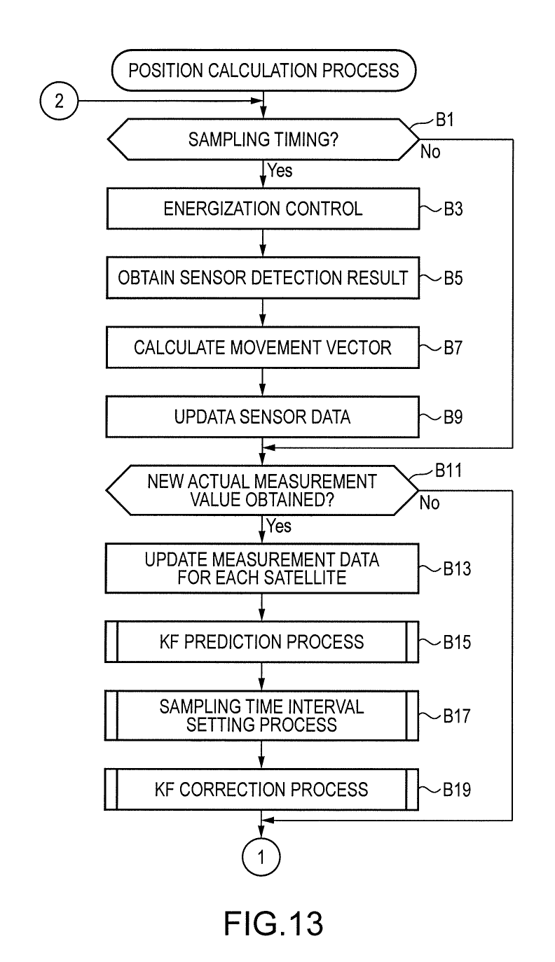

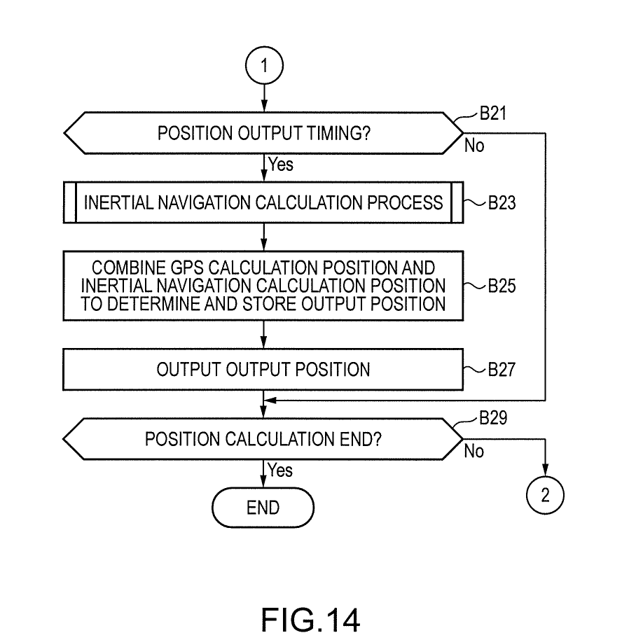

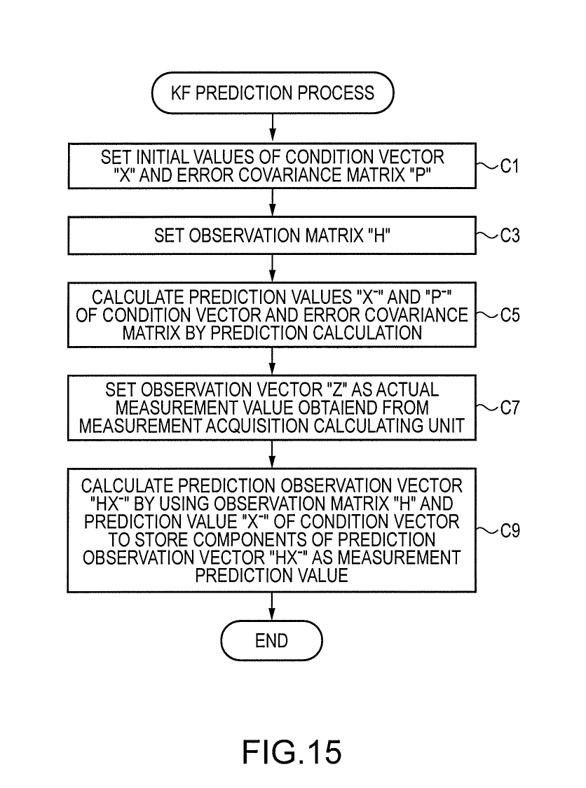

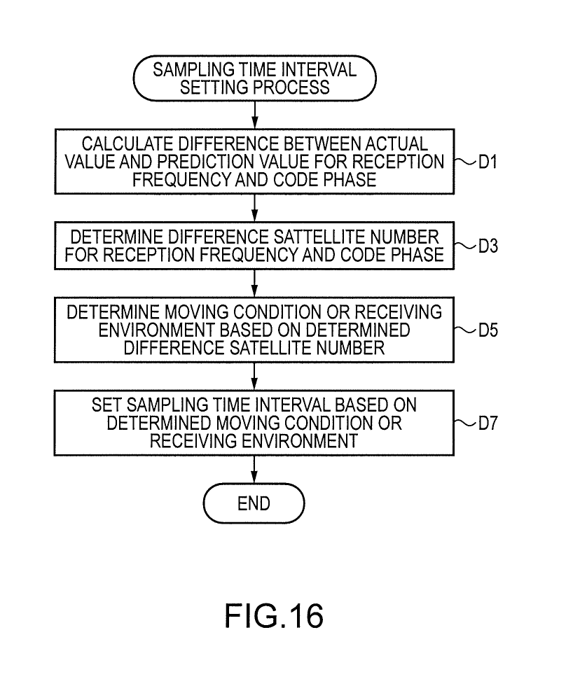

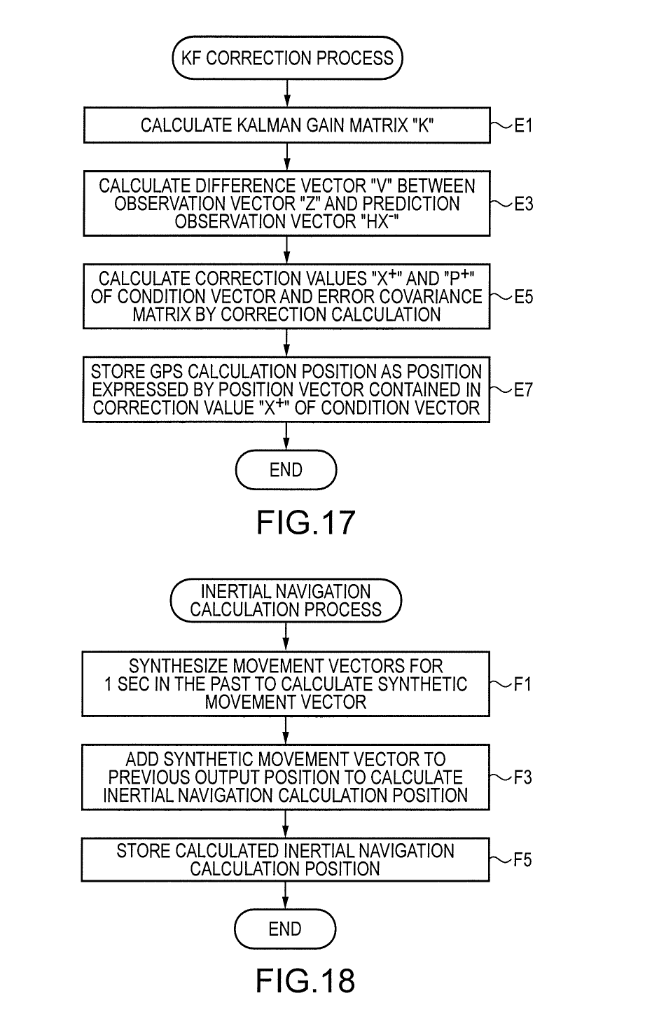

The main program 111 contains a position calculating program 1111 performed in position calculation process (see FIGS. 13 and 14), a KF prediction program 1113 performed in KF (Kalman filter) prediction process (see FIG. 15), a KF correction program 1115 performed in KF correction process (see FIG. 17), an inertial navigation calculation program 1117 performed in inertial navigation calculation process (see FIG. 18), and a sampling time interval setting program 1119 performed in sampling time interval setting process (see FIG. 16) as sub routines.

In the main process, the host CPU 40 performs process for providing telephone communication and mail transmission and reception as the original function of the cellular phone, and process for calculating the position of the cellular phone 1 under the position calculation process to output the calculated position.

In the KF prediction process, the host CPU 40 performs prediction calculation based on the theory of Kalman filter to calculate a prediction value “X⁻” of condition vector “X” containing the position and moving speed of the cellular phone 1. The host CPU 40 also calculates prediction values of reception frequency and code phase of GPS satellite signals (hereinafter referred to as “measurement prediction values” by using predetermined observation matrix “H” and the prediction value “X⁻”.

In the KF correction process, the host CPU 40 performs correction calculation based on the theory of Kalman filter by using observation information as actual values of reception frequency and code phase of GPS satellite signals obtained and calculated by the measurement acquisition calculating unit 33 (hereinafter referred to as “actual measurement values”) to calculate a correction value “X⁺” of the condition vector “X” containing the position and moving speed of the cellular phone 1.

In the inertial navigation calculation process, the host CPU 40 performs predetermined inertial navigation calculation by using the movement vector calculated based on the detection results from the sensor unit 90 to calculate the inertial navigation calculation position.

In the sampling time interval setting process, the host CPU 40 determines the moving condition of the mobile body or the receiving environment of GPS satellite signals based on the difference between the actual measurement values and the measurement prediction values, and sets the sampling time intervals for intermittently operating the sensor unit 90 based on the determination result.

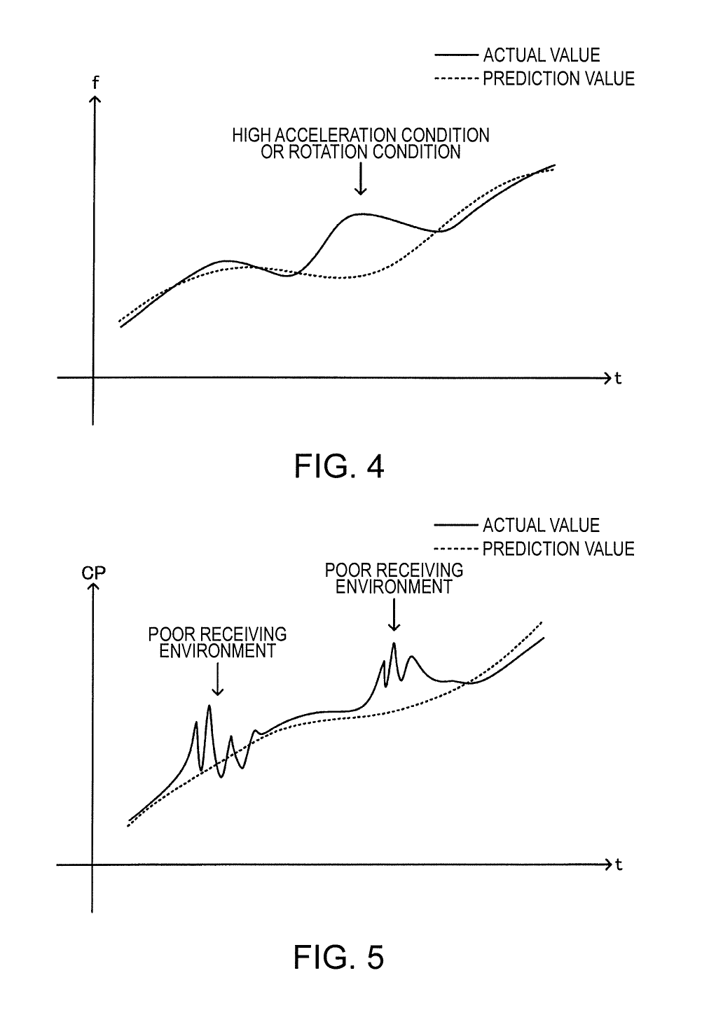

FIG. 4 is a graph showing an example of changes of actual values and prediction values of reception frequency of GPS satellite signals with time. In this graph, the horizontal axis indicates time, and the vertical axis indicates reception frequency. A solid line shows actual values of reception frequency, and a dotted line indicates prediction values of reception frequency.

The experiments conducted by the present inventors led to the conclusion that the difference between the actual values and prediction values of reception frequency under unstable moving condition of the mobile body such as high acceleration condition and rotation condition becomes larger than that under stable moving condition of the mobile body such as stop condition and uniform motion condition. Based on this conclusion, it is determined that the possibility of high acceleration condition or rotation condition of the mobile body becomes higher as the number of GPS satellites SV having large difference between actual values and prediction values of reception frequency increases. In this embodiment, therefore, the sampling time intervals are set short in this case.

FIG. 5 is a graph showing an example of changes of actual values and prediction values of code phase of GPS satellite signals with time. In this graph, the horizontal axis indicates time, and the vertical axis indicates code phase. A solid line shows actual values of code phase, and a dotted line shows prediction values of code phase.

The experiments similarly conducted for code phase led to the conclusion that the difference between the actual values and prediction values of code phase under poor environment for receiving GPS satellite signals becomes larger than that under preferable receiving environment. Based on this conclusion, it is determined that the GPS satellite signal receiving environment becomes poorer as the number of GPS satellite signals SV having large difference between the actual values and prediction values increases. In this embodiment, therefore, the sampling time intervals are set short in this case.

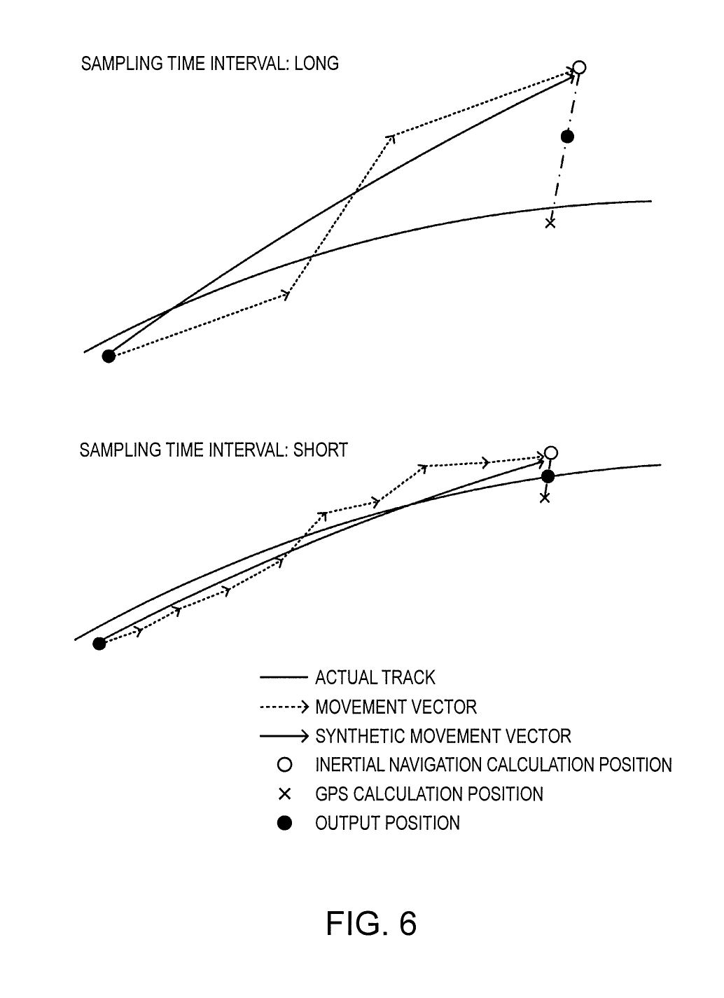

The accuracy in position calculation in accordance with difference in the sampling time interval is now discussed with reference to FIG. 6. The upper part in FIG. 6 shows changes of output positions with time when the sampling time interval is set long, and the lower part shows changes of output positions with time when the sampling time interval is set short. A solid line shows actual track of the mobile body. A dotted line with arrows shows movement vector of the mobile body. A solid line with arrow shows synthetic movement vector. A white circle shows inertial navigation calculation position calculated by inertial navigation calculation. A “×” mark shows GPS calculation position calculated based on a GPS satellite signal. A black circle shows output position.

The host CPU 40 calculates movement vector containing the moving speed and azimuth of the mobile body every time the sensor unit 90 conducts detection. Then, at the output timing of the position (in this embodiment, at intervals of one second) the host CPU 40 synthesizes the movement vectors calculated for 1 second in the past to calculate the synthetic movement vector. Subsequently, the host CPU 40 adds the calculated synthetic movement vector to the previous output position to calculate the inertial navigation calculation position. Finally, the host CPU 40 combines the calculated inertial navigation calculation position and the GPS calculation position to determine the final output position.

When the sampling time interval is set long, the time interval for detection by the sensor unit 90 becomes long. Thus, the time interval for movement vector calculation increases accordingly. In this case, once an erroneous movement vector is calculated, this erroneous movement vector is maintained until the next movement vector calculation time. Under this condition, synthetic movement vector appropriately representing moving condition of the mobile body cannot be obtained, and thus accuracy in inertial navigation calculation lowers. Accordingly, the output position obtained by combining the GPS calculation position and the inertial navigation calculation position is deviated from the actual position of the mobile body.

When the sampling time interval is set short, the time interval for detection by the sensor unit 90 becomes short. Thus, the time interval for movement vector calculation becomes short accordingly. In this case, even when an erroneous movement vector is calculated, the next movement vector is calculated immediately. Under this condition, synthetic movement vector appropriately representing moving condition of the mobile body can be obtained, and thus accuracy in inertial navigation calculation improves. Accordingly, the output position obtained by combining the GPS calculation position and the inertial navigation calculation position comes close to the actual position of the mobile body.

According to this embodiment, the sampling time interval is set every time the actual measurement value is obtained by the measurement acquisition calculating unit 33. The time interval for obtaining the actual measurement value by the measurement acquisition calculating unit 33 is set at a time interval shorter than 1 second as position output timing (such as 100 milliseconds).

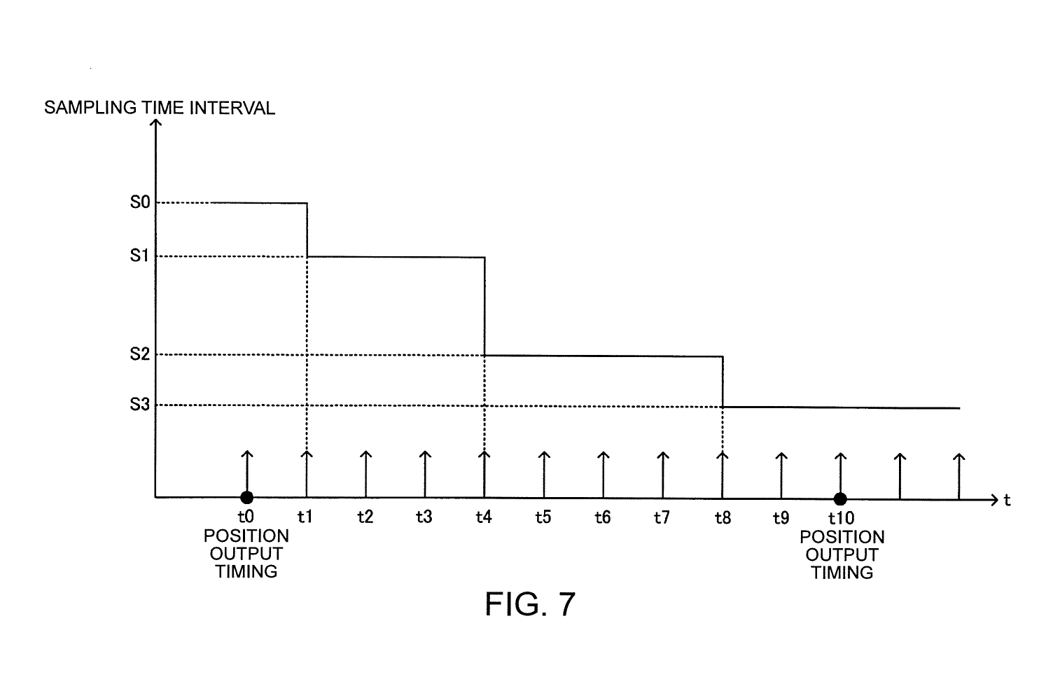

FIG. 7 is a graph showing an example of changes of sampling time intervals with time. In FIG. 7, the horizontal axis indicates time, and the vertical axis indicates sampling time intervals. Black circles show position output timing. Arrows directed upward show times at which actual measurement values are obtained.

At a time “t0” as a position output timing, the sampling time interval is set at “S0”. Then, the sampling time interval is set every time the actual measurement value is obtained. More specifically, the sampling time interval is reduced to “S1” at a time “t1”. During the period from “t1” to “t4”, the sampling time interval remains as “S1”. At the time “t4”, the sampling time interval is reduced to “S2”. During the period from “t4” to “t8”, the sampling time interval remains as “S2”. At the time “t8”, the sampling time interval is reduced to “S3”.

Thus, the sampling time interval is as short as “S3” at a time “t9”. In this case, the preparation for performing highly accurate inertial navigation calculation can be provided at a stage before a time “t10” as the position output timing. Accordingly, highly accurate position calculation can be performed at the time “t10” as the position output timing.

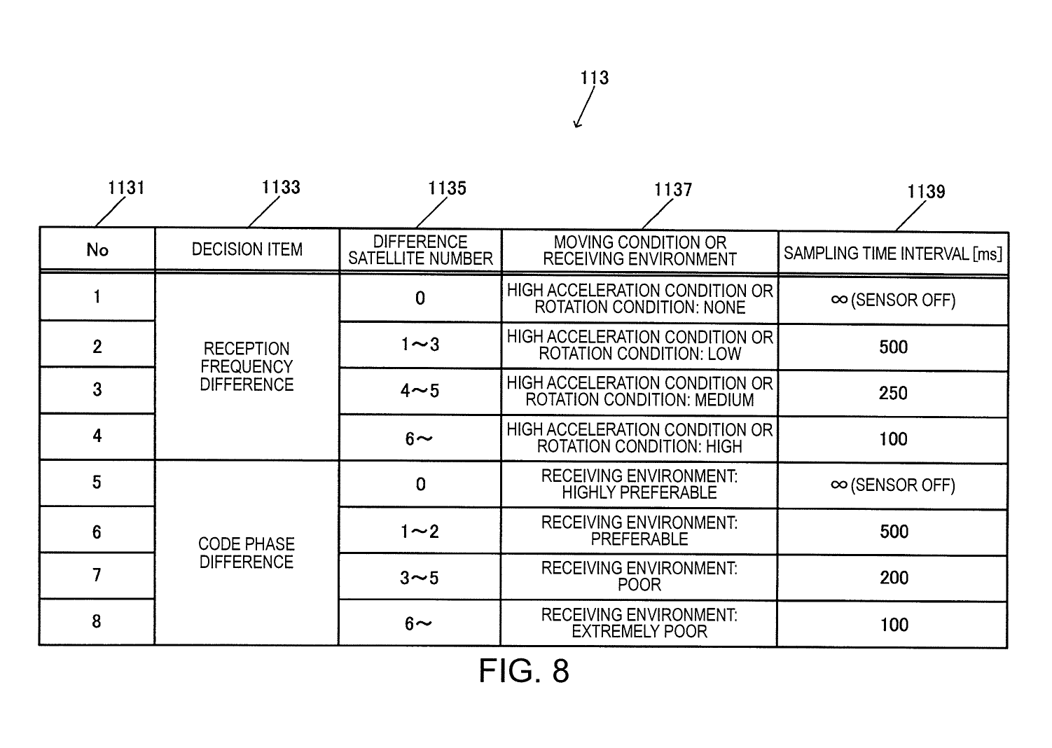

FIG. 8 shows an example of data structure of the sampling time interval setting data 113. The sampling time interval setting data 113 stores number 1131, decision item 1133, difference satellite number 1135, moving condition or receiving environment 1137, and sampling time interval 1139 in association with one another.

The decision item 1133 stores reception frequency difference and code phase difference. The reception frequency difference indicates that the difference between the reception frequency of the GPS satellite signal obtained from the measurement acquisition calculating unit 33 and the reception frequency predicted in the KF prediction process exceeds a predetermined threshold. The code phase difference indicates that the difference between the code phase of the GPS satellite signal obtained from the measurement acquisition calculating unit 33 and the code phase of the GPS satellite signal predicted in the KF prediction process exceeds a predetermined threshold.

The difference satellite number 1135 shows the number of GPS satellites satisfying the conditions of the reception frequency difference and the code phase difference. The moving condition or receiving environment 1137 shows the current moving condition of the mobile body or GPS satellite signal receiving environment. It is determined that the possibility of high acceleration condition or rotation condition of the mobile body becomes higher as the reception frequency difference satellite number 1135 increases. It is also determined that the environment for receiving GPS satellite signals becomes poorer as the code phase difference satellite number 1135 increases.

The sampling time interval 1139 is a sampling time interval set in the moving condition or receiving environment 1137, and a shorter time interval is set as the possibility of high acceleration condition or rotation condition of the mobile body is higher. Also, a shorter time interval is set as the GPS satellite signal receiving environment is poorer.

When the reception frequency difference satellite number is “1 to 3”, for example, the moving condition of the mobile body is determined as “low possibility of high acceleration condition or rotation condition”. In this case, the sampling time interval is set at “500 milliseconds”. When the reception frequency difference satellite number is “6 or more”, the moving condition of the mobile body is determined as “high possibility of high acceleration condition or rotation condition”. In this case, the sampling time interval is set at “100 milliseconds”.

When the code phase difference satellite number is “0”, the environment for receiving GPS satellite signals is determined as “highly preferable”. In this case, the sampling time interval is set at “∞ (sensor OFF)”. When the code phase difference satellite number is “3 to 5”, the environment for receiving GPS satellite signals is determined as “poor”. In this case, the sampling time interval is set at “200 milliseconds”.

When the sampling time interval determined based on reception frequency is different from the sampling time interval determined based on code phase, the shorter sampling time interval is selected and set.

FIG. 3 shows an example of data stored in the RAM 120. The RAM 120 stores sensor data 121, measurement data for each satellite 123, measurement history data 125, and KF parameter data 127.

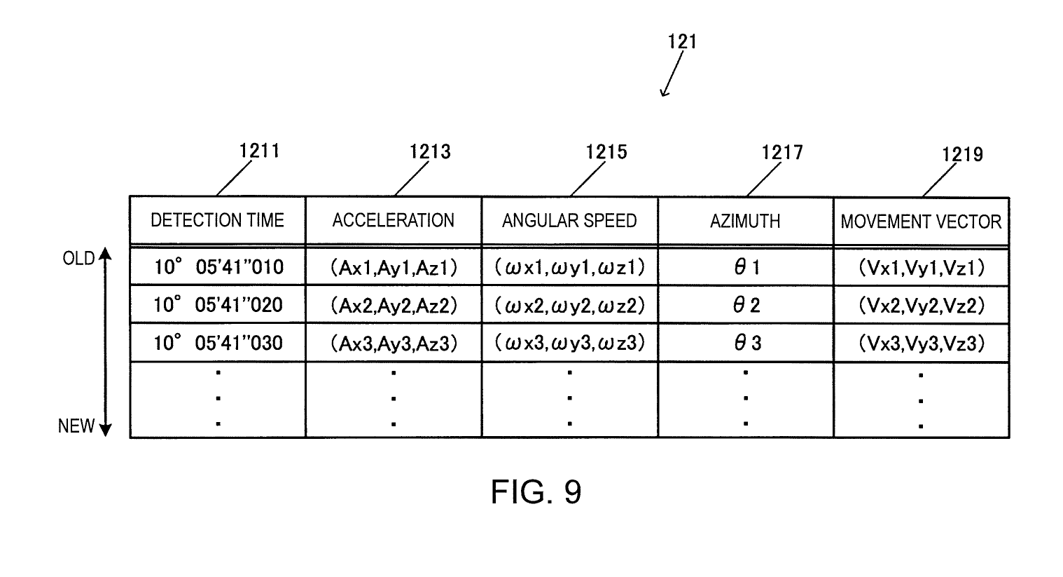

FIG. 9 shows an example of data structure of the sensor data 121. The sensor data 121 stores three-dimensional acceleration 1213 detected by the acceleration sensor 91, three-dimensional angular speed 1215 detected by the gyro sensor 93, azimuth 1217 detected by the azimuth sensor 95, and movement vector 1219 calculated from these detection results in association with detection time 1211. The detection time 1211 is determined at the sampling time intervals set by the host CPU 40.

For example, the acceleration 1213 detected at the detection time “10° 05′ 41″ 010” is expressed as “(Ax1, Ay1, Az1)”, the angular speed 1215 detected at that time is expressed as “(ωx1, ωy1, ωz1)”, and the azimuth 1217 is expressed as “θ1”. In this case, the movement vector 1219 is expressed as “(Vx1, Vy1, Vz1)”.

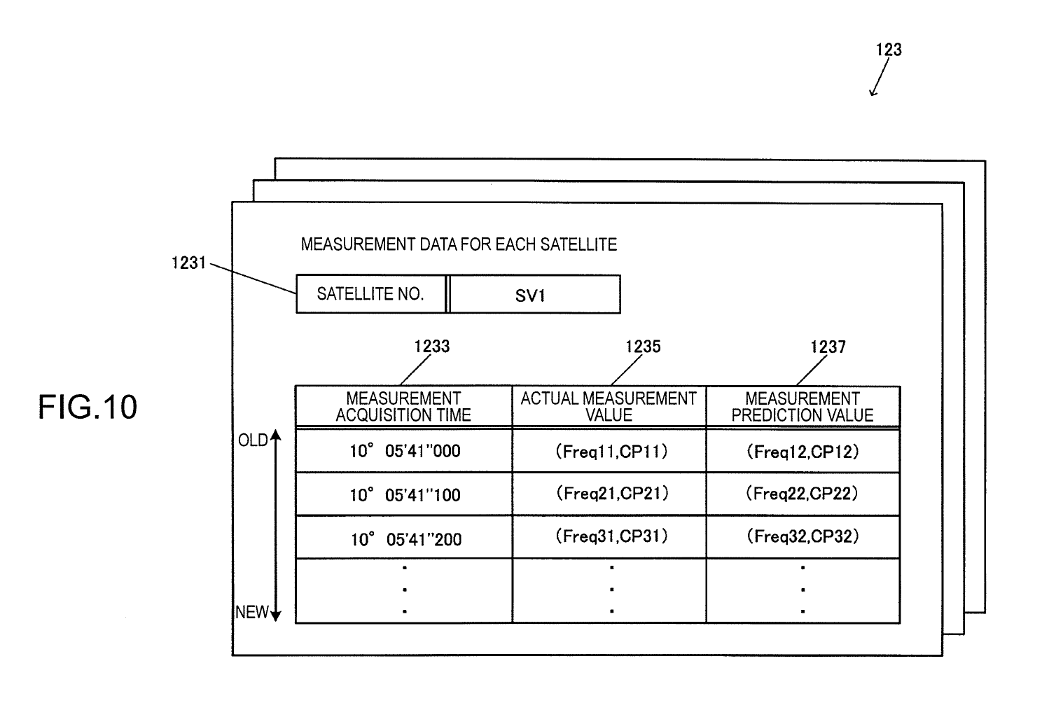

FIG. 10 shows an example of data structure of the measurement data for each satellite 123. The measurement data for each satellite 123 stores measurement acquisition time 1233 at which the actual measurement value is obtained from the corresponding capture satellite, actual measurement value 1235 as actual values of reception frequency and code phase of the GPS satellite signal obtained by the measurement acquisition calculating unit 33, and measurement prediction value 1237 as prediction values of reception frequency and code phase of the GPS satellite signal predicted in the KF prediction process in association with one another for each capture satellite number 1231. The measurement acquisition time 1233 is determined at 100 msec. time intervals, for example.

For example, the actual measurement value 1235 obtained at the measurement acquisition time “10° 05′ 41″ 100” for a capture satellite “SV1” has reception frequency “Freq21”, and code phase “CP21”. The measurement prediction value 1237 at that time has reception frequency “Freq22” and code phase “CP22”.

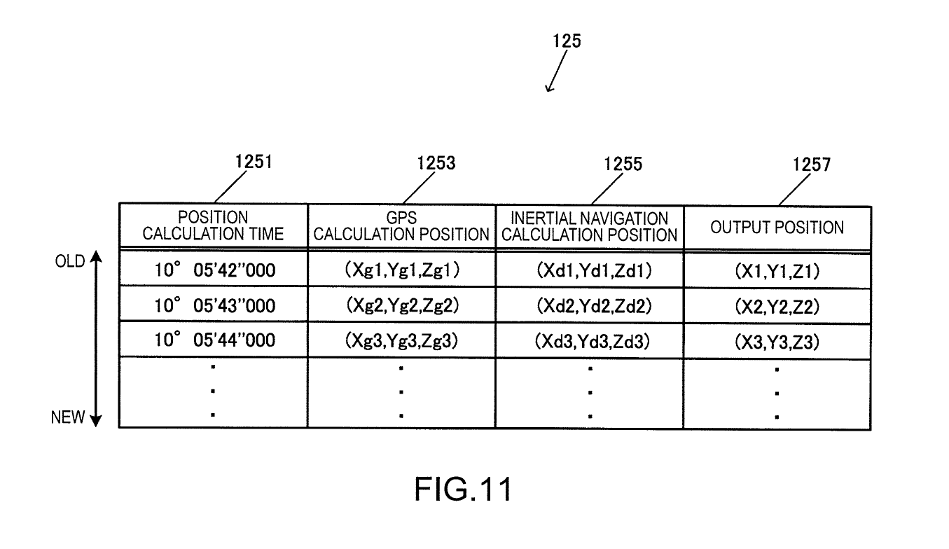

FIG. 11 shows an example of data structure of the measurement history data 125. The measurement history data 125 stores position calculation time 1251, GPS calculation position 1253 calculated at the corresponding position calculation time, inertial navigation calculation position 1255, and output position 1257 in association with each other. The position calculation time 1251 is determined at intervals of 1 second, for example.

For example, at the position calculation time “10° 05′ 42″ 000”, GPS calculation position “(Xg1, Yg1, and Zg1)”, inertial navigation calculation position “(Xd1, Yd1, Zd1)”, and output position “(X1, Y1, Z1)” are stored.

Returning to FIG. 3, the KF parameter data 127 is data storing various parameters of Kalman filter used in the KF prediction process and the KF correction process, and is updated by the host CPU 40 in these processes.

### 3. Flow of Process

FIG. 12 is a flowchart showing the flow of the main process performed by the cellular phone 1 under the main program 111 stored in the ROM 110 and read and executed by the host CPU 40. The main process is initiated when the host CPU 40 detects power supply operation inputted to the cellular phone 1.

Though not particularly described, reception of RF signals by the GPS antenna 10, down conversion into IF signals by the RF receiving circuit unit 21, acquisition and calculation of information including reception frequency and code phase of GPS satellite signals (actual measurement values) by the measurement acquisition calculating unit 33, and other processes are performed as necessary during execution of the following main process.

Initially, the host CPU 40 determines command operation inputted through the operation unit 50 (step A1). When it is determined that the command operation is telephone communication command operation (step A1; telephone communication command operation), the host CPU 40 performs telephone communication process (step A3). More specifically, the cellular phone wireless communication circuit unit 80 communicates with a base station such that telephone communication can be provided between the cellular phone 1 and other device under the control of the host CPU 40.

When it is determined that the command operation is mail transmission and reception command operation in step A1 (step A1; mail transmission and reception command operation), the host CPU 40 performs mail transmission and reception process (step A5). More specifically, the cellular phone wireless communication circuit unit 80 communicates with a base station such that mail transmission and reception can be achieved between the cellular phone 1 and other device under the control of the host CPU 40.

When it is determined that the command operation is position calculation command operation in step A1 (step A1; position calculation command operation), the host CPU 40 reads and executes the position calculation program 1111 stored in the ROM 110 to perform the position calculation process (step A7).

FIGS. 13 and 14 are flowcharts showing the flow of the position calculation process.

Initially, the host CPU 40 determined whether it is the sampling timing or not (step B1). When it is determined that it is not the sampling timing (step B1; NO), the flow goes to step B11.

When it is determined that it is the sampling timing (step B1; YES), the host CPU 40 controls the energization control unit 100 such that the sensor unit 90 can be energized (step B3). Then, the host CPU 40 obtains detection results from the sensor unit 90 (step B5). When the host CPU 40 obtained the detection results, host CPU 40 controls the energization control unit 100 such that the sensor unit 90 can not be energized.

The host CPU 40 calculates movement vector by using the detection results obtained from the sensor unit 90 in step B5 (step B7). Then, the host CPU 40 stores the detection results 1213 through 1217 obtained from the sensor unit 90 and the calculated movement vector 1219 in the sensor data 121 in association with the detection time 1211 (step B9).

The host CPU 40 determines whether the new actual measurement value 1235 is obtained from the measurement acquisition calculating unit 33 (step B11). When it is determined that the new actual measurement value 1235 is not obtained (step B11; NO), the host CPU 40 shifts the flow to step B21.

When it is determined that the new actual measurement value 1235 is obtained (step B11; YES), the host CPU 40 stores the obtained actual measurement value 1235 in the measurement data for each satellite 123 in association with the capture satellite number 1231 and the measurement acquisition time 1233 (step B13). Then, the host CPU 40 reads and executes the KF prediction program 1113 stored in the ROM 110 to perform the KF prediction process (step B15).

FIG. 15 is a flowchart showing the flow of the KF prediction process.

Initially, the host CPU 40 sets KF initial values for KF process condition vector “X” and error covariance matrix “P” (step C1). In the KF process, prediction process and correction process are performed by using condition vector expressed by 8×1 matrix containing components of position vector “(x, y, z)”, moving speed vector “(u, v, w)”, bias of clock “b”, and drift of clock “d” of the cellular phone 1.

The error covariance matrix “P” is 8×8 matrix representing error covariance of eight-dimensional respective components of the condition vector “X”. The initial values of the condition vector “X” and the error covariance matrix “P” can be determined as correction values “X⁺” and “P⁺” of the condition vector “X” and the error covariance matrix “P” obtained in the KF correction process at one time before the current time, for example.

Then, the host CPU 40 sets the observation matrix “H” (step C3). The observation matrix “H” is a matrix for predicting reception frequency and code phase of the GPS satellite signal as the components of the observation vector “Z” by using the respective components of the prediction value “X⁻” of the condition vector. The observation matrix “H” is 2×8 matrix, and the prediction value “X⁻” of the condition vector is 8×1 matrix. Thus, the prediction observation vector “HX⁻” can be obtained as 2×1 matrix.

Then, the host CPU 40 performs prediction calculation for the condition vector “X” and the error covariance matrix “P” according to the following equations (1) and (2) to calculate the prediction value “X⁻” of the condition vector and the prediction value “P⁻” of the error covariance matrix (step C5).

X⁻(t)=φ(t)X⁺(t−1) (1)

P⁻(t)=φ(t)P⁺(t−1)φ^{T}(t)+Q(t−1) (2)

In these equations, subscript “−” indicates prediction value, subscript “+” indicates correction value, and subscript “T” indicates transposed matrix. Also, “φ” is 8×8 matrix representing transition of the condition vector “X” and called condition transition matrix, and “Q” is 8×8 matrix representing allowance of fluctuations of the condition vector “X” and called system noise matrix. Each of the condition transition matrix “φ” and the system noise matrix “Q” may be a predetermined matrix.

Then, the host CPU 40 sets the observation vector “Z” as 2×1 matrix containing the components of the actual values of reception frequency and code phase of the GPS satellite signal stored in the measurement data for each satellite 123 of the RAM 120 as the latest actual measurement value 1235 (step C7).

Subsequently, the host CPU 40 multiplies the prediction value “X⁻” calculated in step C5 by the observation matrix “H” set in step C3 to calculate the prediction observation vector “HX⁻”, and stores the measurement prediction value 1237 as the prediction values of the reception frequency and code phase of the GPS satellite signal as the components of the prediction observation vector “HX⁻” in the measurement data for each satellite 123 (step C9). Then, the host CPU 40 ends the KF prediction process.

Returning to the position calculation process shown in FIG. 13, the host CPU 40 having finished the KF prediction process reads and executes the sampling time interval setting program 1119 stored in the ROM 110 to perform the sampling time interval setting process (step B17).

FIG. 16 is a flowchart showing the flow of the sampling time interval setting process.

Initially, the host CPU 40 calculates difference between the actual value and the prediction value for each of the reception frequency and the code phase of the GPS satellite signal by using the latest actual measurement value and the measurement prediction value stored in the measurement data for each satellite 123 of the RAM 120 (step D1).

The host CPU 40 determines the number of satellites having difference exceeding a predetermined threshold (difference satellite number 1135) for each of the reception frequency and the code phase (step D3). Then, the host CPU 40 determines the moving condition or receiving environment 1137 corresponding to the determined difference satellite number 1135 by referring to the sampling time interval data 113 stored in the ROM 110 (step D5).

The host CPU 40 reads and sets the sampling time interval 1139 corresponding to the moving condition or receiving environment 1137 determined in step D5 by referring to the sampling time interval setting data 113 (step D7). Then, the host CPU 40 ends the sampling time interval setting process.

Returning to the position calculation process shown in FIG. 13, the host CPU 40 having finished the sampling time interval setting process reads and executes the KF correction program 1115 stored in the ROM 110 to perform the KF correction process (step B19).

FIG. 17 is a flowchart showing the flow of the KF correction process.

Initially, the host CPU 40 calculates Kalman gain matrix “K” according to the following equation (3) by using the prediction value “P⁻” of the error covariance matrix “P” and the observation matrix “H” obtained in the KF prediction process (step E1).

K(t)=P⁻(t)H^{T}(t)[H(t)P⁻(t)H^{T}(t)+R]⁻¹ (3)

The Kalman gain matrix “K” is 8×2 matrix, and “R” is 2×2 matrix representing error covariance of respective components of the observation vector “Z” and called observation error covariance matrix.

The host CPU 40 calculates difference vector “V” between the observation vector and the prediction observation vector “HX⁻” (step E3). Then, the host CPU 40 performs correction calculation for calculating the correction value “X⁺” of the condition vector and the correction value “P⁺” of the error covariance matrix according to the following equations (4) and (5) (step E5).

X⁺(t)=X⁻(t)+K(t)V(t)=X⁻(t)+K(t)[Z(t)−H(t)X⁻(t)] (4)

P⁺(t)=[I−K(t)H(t)]P⁻(t) (5)

In the above equation, “I” is unit matrix.

The host CPU 40 stores the GPS calculation position 1253 as the position represented by a position vector “(x, y, z)” contained in the correction value “X⁺” of the condition vector calculated in the correction calculation in the measurement history data 125 (step E7). Then, the host CPU 40 ends the KF correction process.

Returning to the position calculation process shown in FIG. 14, the host CPU 40 having finished the KF correction process determines whether it is the position output timing or not (step B21). When it is determined that it is not the position output timing yet (step B21; NO), the flow goes to step B29. When it is determined that it is the position output timing (step B21; YES), the host CPU 40 reads and executes the inertial navigation calculation program 1117 stored in the ROM 110 to perform the inertial navigation calculation process (step B23).

FIG. 18 is a flowchart showing the flow of the inertial navigation calculation process.

Initially, the host CPU 40 synthesizes the movement vectors 1219 for 1 second in the past stored in the sensor data 121 of the RAM 120 to calculate synthetic movement vector (step F1). Then, the host CPU 40 adds the synthetic movement vector to the previous output position 1257 stored in the measurement history data 125 of the RAM 120 to calculate the inertial navigation calculation position 1255 (step F3). Subsequently, the host CPU 40 stores the calculated inertial navigation calculation position 1255 in the measurement history data 125 (step F5), and ends the inertial navigation calculation process.

Returning to the position calculation process shown in FIG. 14, the host CPU 40 having finished the inertial navigation calculation process combines the latest GPS calculation position 1253 stored in the measurement history data 125 of the RAM 120 and the inertial navigation calculation position 1255 according to the following equation (6) to determine the output position 1257, and stores the output position 1257 in the measurement history data 125 (step B25).

p=α·p_{d}+(1−α)·p_{g} (6)

In the above equation, “p” represents output position, “p_{d}” represents inertial navigation calculation position, “p_{g}” represents GPS calculation position, and “α” represents weight for determining which of the inertial navigation calculation position and the GPS calculation position is more important. For example, calculation is performed setting “α=0.5”.

The host CPU 40 produces a navigation screen where the determined output position 1257 is plotted and displays the screen on the display unit 60 (step B27). Then, the host CPU 40 determines whether position calculation end command is issued from the user through the operation unit 50 (step B29). When it is determined that the end command is not issued (step B29; NO), the flow returns to step B1. When it is determined that the position calculation end command is issued (step B29; YES), the position calculation process ends.

Returning to the main process shown in FIG. 12, the host CPU 40 having finished any of the processes in steps A3 through A7 determines whether power source cutoff command operation is performed by the user through the operation unit 50 (step A9). When it is determined that the cutoff command operation is not performed (step A9; NO), the flow returns to step A1. When it is determined that the power source cutoff command operation is performed (step A9; YES), the main process ends.

### 4. Operation and Advantage

The host CPU 40 of the cellular phone 1 carried with or mounted on the mobile body intermittently operates the sensor unit 90 for detecting the moving condition of the mobile body in predetermined intermittent operation cycle. This intermittent operation cycle is variably controlled according to the GPS satellite signal receiving condition. The host CPU 40 performs the predetermined inertial navigation calculation based on the detection results from the sensor unit 90 operated in the intermittent operation cycle to calculate the inertial navigation calculation position, and combines the GPS calculation position and the inertial navigation calculation position to determine the output position.

When the GPS satellite signal receiving condition is preferable, it is probable that the GPS calculation position is highly accurate. Thus, the inertial navigation calculation position need not be highly accurate. In this case, therefore, the intermittent operation cycle of the sensor unit 90 is set long. When the GPS satellite signal receiving condition is not preferable, it is probable that the GPS calculation position is not accurate. Thus, the inertial navigation calculation position needs to be highly accurate. In this case, therefore, the intermittent operation cycle of the sensor unit 90 is set short. By this method, appropriate position calculation considering balance between the accuracy of position calculation and the power consumption of the sensor unit can be achieved.

### 5. Modified Example

### 5-1. Electronic Device

The invention is applicable to any types of electronic device provided with a position calculating device as well as a cellular phone. For example, the invention can be similarly applied to a portable personal computer, a PDA (personal digital assistant), a car navigation system, a portable navigation device, and other devices.

### 5-2. Satellite Position Calculation System

The GPS has been described as an example of the satellite position calculation system in this embodiment. However, the satellite position calculation system may be WAAS (wide area augmentation system), QZSS (quasi zenith satellite system), GLONASS (global navigation satellite system), GALILEO or the like.

### 5-3. Division of Process

A part or the whole of the process performed by the host CPU 40 may be carried out by the calculation control unit 31 of the baseband processing circuit unit 30. For example, the calculation control unit 31 performs the position calculation process by using the actual measurement value calculated by the measurement acquisition calculating unit 33 to determine the output position.

### 5-4. Determination of Moving Condition or Receiving Environment

According to this embodiment, the moving condition of the mobile body or the GPS satellite signal receiving environment is determined based on the number of satellites having reception frequency difference and code phase difference. However, the movement condition or the receiving environment may be determined based on the reception frequency difference and the code phase difference.

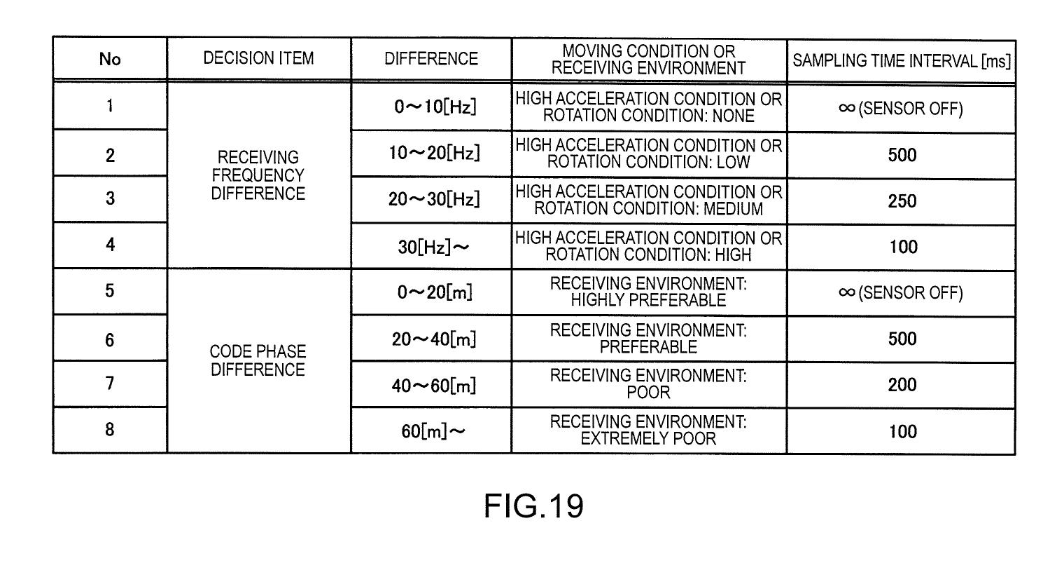

FIG. 19 shows an example of data structure of sampling time interval setting data stored in the ROM 110 in this case. The sampling time interval setting data shown in FIG. 19 stores reception frequency difference and code phase difference instead of the number of satellites having reception frequency difference and code phase difference. In this case, the host CPU 40 calculates the average of the reception frequency difference and the code phase difference calculated for all of the capture satellites, and reads the moving condition or receiving environment corresponding to the calculated difference average to determine the moving condition of the mobile body or GPS satellite signal receiving environment, for example.

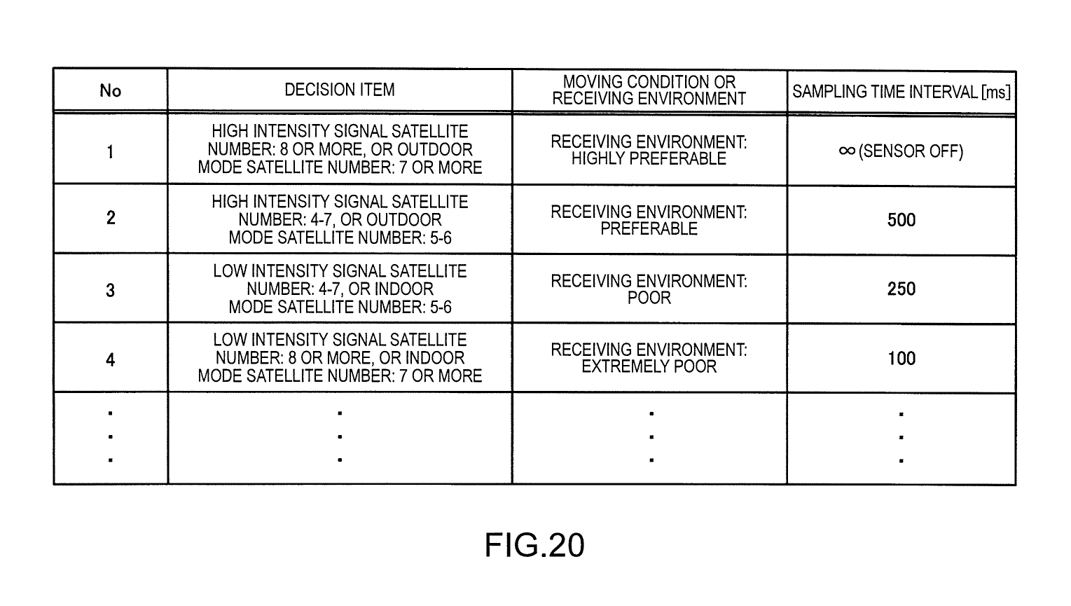

The decision items for determining the moving condition or receiving environment are not limited to receiving frequency and code phase. For example, as shown in the sampling time interval setting data shown in FIG. 20, the number of high intensity signal satellites, the number of low intensity signal satellites, the number of outdoor mode satellites, and the number of indoor mode satellites may be set as decision items.

The high intensity signal satellites are satellites which receive GPS satellite signals having signal intensity exceeding a predetermined threshold (such as “−130 dBm”). The low intensity signal satellites are satellites which receive GPS satellite signals having signal intensity lower than predetermined threshold (such as “−145 dBm”).

The outdoor mode satellites and indoor mode satellites are satellites captured in outdoor mode and indoor mode, respectively. The outdoor mode is a position calculation mode appropriate when the position calculating device is disposed outdoor, and the indoor mode is a position calculation mode appropriate when the position calculating device is disposed indoor.

Under the outdoor environment, received GPS satellite signals become strong electric field signals. In this case, the peak of the correlation values can be easily determined in the correlation process between the PRN code of the GPS satellite signals and the replica code. Thus, the correlation process is performed with reduced time for integrating correlation values (generally shorter than 1 second) to obtain reception frequency and code phase of GPS satellite signals. Thus, the outdoor mode is short integration time mode.

On the other hand, under the indoor environment, received GPS satellite signals become week electric field signals. In this case, the peak of the correlation values is difficult to be determined in the correlation process. Thus, the correlation process is performed with increased time for integrating the correlation values (generally 1 second or longer) to obtain reception frequency and code phase of GPS satellite signals. In this case, the indoor mode is long integration time mode.

For example, when the condition that the number of high intensity signal satellites is 8 or larger, or that the number of outdoor mode satellites is 7 or larger is satisfied, the GPS satellite signal receiving environment is determined as “highly preferable”. Thus, the sampling time interval is set at “∞ (sensor OFF)”. When the condition that the number of low intensity signal satellites is 4 to 7, or that the number of indoor mode satellites is 5 to 6 is satisfied, the GPS satellite signal receiving environment is determined as “poor”. In this case, the sampling time interval is set at “250 milliseconds”.

### 5-5. Determination Based on Receiving Condition History

According to this embodiment, the mobile body moving condition or the GPS satellite signal receiving environment is determined based on the latest reception frequency and code phase. However, these condition and environment may be determined based on reception frequencies and code phases for a predetermined period in the past (receiving condition history).

For example, the average of the actual values and the average of the prediction values for 1 second in the past are calculated by arithmetic mean calculation for each of reception frequency and code phase. Then, the mobile body moving condition or the GPS satellite signal receiving environment is determined by determining the difference between the calculated average of the actual values and average of the prediction values for each of reception frequency and code phase.

The averages of reception frequency and code phase may be calculated not by the simple arithmetic mean calculation but by weighted mean calculation. For example, weighted mean calculation may be performed such that newer reception frequency and code phase become more important. In this case, newer reception frequency and code phase are more weighted for reception frequency and code phase for 1 second in the past before weighted mean calculation, and weighted average is calculated for each of the actual values and the prediction values.

What is claimed is:

1. A position calculating method performed by a position calculating device carried with or mounted on a mobile body and moving with the mobile body, comprising:
receiving a positioning signal from a positioning satellite;
calculating a position based on the received positioning signal;
intermittently operating a sensor unit which detects moving condition of the mobile body in predetermined intermittent operation cycle;
controlling the intermittent operation cycle according to the positioning signal receiving condition;
calculating a position by executing predetermined inertial navigation calculation by using a detection result from the sensor unit operated in the intermittent operation cycle; and
determining an output position by using the position calculated based on the positioning signal and the position calculated by the inertial navigation calculation.

2. The position calculating method according to claim 1, further comprising:
predicting position and moving speed of the mobile body by performing prediction calculation based on Kalman filter theory;
predicting frequency of the positioning signal received at the predicted position by using the predicted position and moving speed; and
controlling the intermittent operation cycle based on the difference between the predicted frequency and the frequency of the received positioning signal.

3. The position calculating method according to claim 2, further comprising:
predicting phase of the positioning signal received at the predicted position by using the predicted position and moving speed; and
controlling the intermittent operation cycle based on the difference between the predicted phase and the phase of the received positioning signal.

4. The position calculating method according to claim 3, further comprising:
predicting the frequency and phase at predetermined intervals; and
controlling the intermittent operation cycle every time prediction is executed at the predetermined intervals.

5. The position calculating method according to claim 1, further comprising controlling the intermittent operation cycle based on history of the positioning signal receiving condition.

6. The position calculating method according to claim 1, further comprising:
determining the moving condition of the mobile body from the positioning signal receiving condition; and
controlling the intermittent operation cycle based on the moving condition of the mobile body.

7. The position calculating method according to claim 1, further comprising:
determining the positioning signal receiving environment from the positioning signal receiving condition; and
controlling the intermittent operation cycle based on the receiving environment.

8. A position calculating device carried with or mounted on a mobile body and moving with the mobile body, comprising:
a receiving unit which receives a positioning signal from a positioning satellite;
a first position calculating unit which calculates a position based on the received positioning signal;
a sensor operation control unit which intermittently operates a sensor unit for detecting moving condition of the mobile body in predetermined intermittent operation cycle;
an operation cycle control unit which controls the intermittent operation cycle according to the positioning signal receiving condition;
a second position calculating unit which calculates a position by executing predetermined inertial navigation calculation by using a detection result from the sensor unit operated in the intermittent operation cycle; and
a position determining unit which determines an output position by using the position calculated based on the positioning signal and the position calculated by the inertial navigation calculation.
